(19) United States
(12) Patent Application Publication
(10) Pub. No.: US 2026/0278268 A1
(43) Pub. Date: Sep. 17, 2026

(54) POLICY-BASED INTER-AGENT COMMUNICATION CONTROL

(71) Applicant: Salesforce, Inc., San Francisco, CA (US)

(72) Inventors: Jose Lejin P J, Bangalore (IN); Ratheesh Krishna Vadhyar, Bangalore (IN)

(21) Appl. No.: 19/082,014

(22) Filed: Mar. 17, 2025

(51) Int. Cl. G06F 40/20; G06F 16/383

(52) U.S. Cl. CPC G06F 40/20; G06F 16/383

(57) ABSTRACT

A system may receive a query via a first agent, where agents are associated with large language model (LLM) prompt templates corresponding with a plurality of operational domains, and where agents are configured to access one or more data stores comprising tagged data. The system may transmit, from the first agent to a second agent a message indicating an operational domain and a requested operation involving first tagged data. The system may verify whether the requested operation is permitted by an agent access policy that indicates a plurality of tags and one or more permitted operations associated with each respective tag. The system may transmit, from the second agent to the first agent, a reply to the message that is in accordance with the agent access policy. The system may transmit a response to the query based on the reply to the message.

### FIELD OF TECHNOLOGY

The present disclosure relates generally to database systems and data processing, and more specifically to policy-based inter-agent communication control.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

In some cloud platform scenarios, artificial intelligence (AI) systems may deploy large language model (LLM) powered agents that may communicate with one another to perform various tasks autonomously or semi-autonomously. However, such methods may be improved.

### BRIEF DESCRIPTION OF THE DRAWINGS

FIG. 1 illustrates an example of a data processing system that supports policy-based inter-agent communication control in accordance with examples as disclosed herein.

FIG. 2 shows an example of a system that supports policy-based inter-agent communication control in accordance with examples as disclosed herein.

FIG. 3 shows an example of a system that supports policy-based inter-agent communication control in accordance with examples as disclosed herein.

FIG. 4 shows an example of a process flow that supports policy-based inter-agent communication control in accordance with examples as disclosed herein.

FIG. 5 shows a block diagram of an apparatus that supports policy-based inter-agent communication control in accordance with examples as disclosed herein.

FIG. 6 shows a block diagram of an inter-agent communication manager that supports policy-based inter-agent communication control in accordance with examples as disclosed herein.

FIG. 7 shows a diagram of a system including a device that supports policy-based inter-agent communication control in accordance with examples as disclosed herein.

FIG. 8 shows a flowchart illustrating methods that support policy-based inter-agent communication control in accordance with examples as disclosed herein.

### DETAILED DESCRIPTION

In an increasingly digital and interconnected world, autonomous agents (e.g., utilizing generative artificial intelligence (AI) to perform processing) may be deployed across industries for tasks like sales improvement, inventory management, customer engagement, scheduling, and cross-functional collaboration. These agents may interact with minimal human intervention, automating processes and decision-making in various environments. Such agents may employ large language models (LLMs) to autonomously generate answers to queries, create multi-step plans to break down a complex task, access external tools and capabilities such as browsing the internet and retrieving data from databases, and employ forms of reasoning. In some systems, agents may autonomously communicate with one or more other agents to perform a task, leading to complex inter-agent communications and actions. However, as the scale and diversity of these agents grow, so do the challenges of maintaining structured and secure communication. The lack of a unified, policy-driven framework for agent interactions introduces risks, inefficiencies, and operational bottlenecks, especially in high-stakes enterprise applications.

The subject matter described herein presents a policy-based structured control system for managing inter-agent communication within autonomous multi-agent environments, addressing considerations for security, privacy, and operational efficiency. The system categorizes and classifies agents by assigning them specific tags based on roles or operational domains, permissions, and functions, while also tagging data resources to control access.

In some examples, generation of many-to-many (M-to-N) association mapping between agents and data resources may be performed, facilitating context-aware interactions based on defined policy rules. In some examples, a policy engine may enforce customizable policies to govern agent-to-agent communication, data access permissions, and autonomous decision-making, promoting compliance with privacy standards and regulatory considerations. In some examples, applying these policies may permit agents to operate autonomously within predefined boundaries, promoting structured, compliant, and efficient interactions in complex autonomous environments. This framework significantly enhances the security, reliability, and scalability of agent-based systems, making them suitable for enterprise and personal use cases where data sensitivity and regulatory compliance are desired.

Aspects of the disclosure are initially described in the context of an environment supporting an on-demand database service. Aspects of the disclosure are then described with reference to systems and a process flow. Aspects of the disclosure are further illustrated by and described with reference to apparatus diagrams, system diagrams, and flowcharts that relate to policy-based inter-agent communication control.

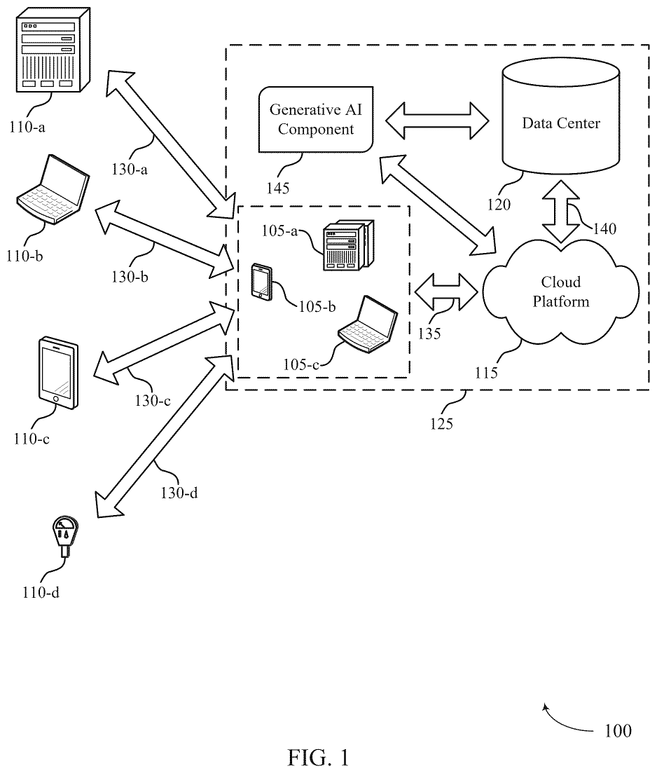

FIG. 1 illustrates an example of a system 100 for cloud computing that supports policy-based inter-agent communication control in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

In some examples, the system 100 may include a generative artificial intelligence (AI) component 145. The generative AI component 145 may be an example or a component of a LLM, such as a generative AI model. In some examples, the generative AI component 145 may additionally, or alternatively, be referred to as any of an AI, a generative AI (GAI), a GAI model, an LLM, a machine learning model, or any similar terminology. The generative AI component 145 may be a model that is trained on a corpus of input data, which may include text, images, video, audio, structured data, or any combination thereof. Such data may represent general-purpose data, domain-specific data, or any combination thereof. Further, the generative AI component 145 may be supplemented with additional training on data associated with a role, function, or generation outcome to further specialize the generative AI component 145 and increase the accuracy and relevance of information generated with the generative AI component 145.

In some examples, the cloud platform 115 may receive a query from a cloud client 105 that may include a request to produce a response (e.g., text, images, video, audio, or other information) to the query using the generative AI component 145. The cloud platform 115 may input a prompt to the generative AI component 145 that includes, or otherwise indicates, the query (or information included therein). The generative AI component 145 may generate an output (e.g., text, images, video, audio, or other information) that is responsive to the prompt. In some examples, the cloud platform 115 may modify or supplement one or more aspects of the query to increase the quality of the response. In some examples, such modification or supplementation may be referred to as grounding.

The system 100 may support any configuration for the use of generative AI models. In FIG. 1, the generative AI component 145 is depicted as being located external to the subsystem 125. However, the generative AI component 145 may be hosted on the cloud platform 115, elsewhere within the subsystem 125, or outside the subsystem 125 (e.g., a publicly-hosted platform). Additionally, or alternatively, multiple generative AI components 145 may be employed to perform one or more of the actions described as being performed by a single generative AI component 145. Further, in some examples, the generative AI component 145 may communicate with one or more other elements, such as a contact 110, the data center 120, one or more other elements, or any combination thereof, to receive additional information (e.g., that may be indicated in the query or the prompt) that is to be considered for performing generative processes.

In various implementations, the models and/or modules described herein (e.g., including, but not limited to, the generative AI component 145) may be classification, predictive, generative, conversational, or another form of AI technology, such as AI model(s), agents, etc., implementing one or more forms of machine learning, a neural network, statistical modeling, deep learning, automation, natural language processing, or other similar technology. The AI technology may be included as part of a network or system comprising a hardware- or software-based framework for training, processing, fine-tuning, or performing any other implementation steps. Furthermore, the AI technology may include a hardware- or software-based framework that performs one or more functions, such as retrieving, generating, accessing, transmitting, etc. The AI technology may be implemented by a computer including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally, or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, one or more input prompts may be provided to the AI technology for the purpose of eliciting particular responses. In various implementations, the input prompts may correspond to the particular field or task to which the AI technology is trained. Additionally, or alternatively, the AI technology may be implemented along with one or more additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

In some cases, a cloud platform 115 may manage one or more agents that may be used for user interactions and for inter-agent interactions. Such agents may be subject to one or more policies that may provide rules by which the agents may perform various operations, such as accessing or processing information, communicating with users, communicating with other agents (e.g., to request or provide data or to perform other operations), or to perform other operations. Such policies, agents, datastores, or any combination thereof, may employ the use of tags to aid in such policy enforcement. In some examples, the cloud platform 115 may map agents to other agents, datastores, or any combination thereof, to obtain relationship information associated with the agents and interactions performed by the agents, which may be used to dynamically update or modify policies. In some examples, the cloud platform 115 may employ the use of modular data structures to facilitate the communication of information between agents (e.g., information that may be used to enforce the policies).

In other approaches, various agents may be employed for different scenarios. However, such approaches do not include any structure, framework, or rules to manage agent-to-agent interactions. Without such a structure, agent-to-agent interactions are, at best, subject to security concerns, inaccurate information, errors, inefficiency, and bottlenecks. Further, such approaches may not account for or be aware of various agent interactions and how the agents interact with other elements of a system (e.g., other agents, datastores, or other system elements).

The subject matter described herein provides a policy-driven framework for agent interactions that govern the behavior and permissions of such agents. For example, various operational domains (e.g., roles) may be performed by an agent, and such operational domains may be tagged. Further, data that may be accessed or modified in association with such operational domains may also be tagged and a mapping or association may be created as a result. Further, the policies may include indications of tags, permitted operations, access controls, and other information that may be used to govern agent access to operations and information (e.g., based on the tags). In at least these ways, context-aware interactions may be performed, promoting increased security, accuracy of information (and generative AI responses generated based upon such information), efficiency may be increased and bottlenecks may be reduced (e.g., because agents are accessing the correct data locations).

It should be appreciated by a person skilled in the art that one or more aspects of the disclosure may be implemented in a system 100 to additionally, or alternatively, solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

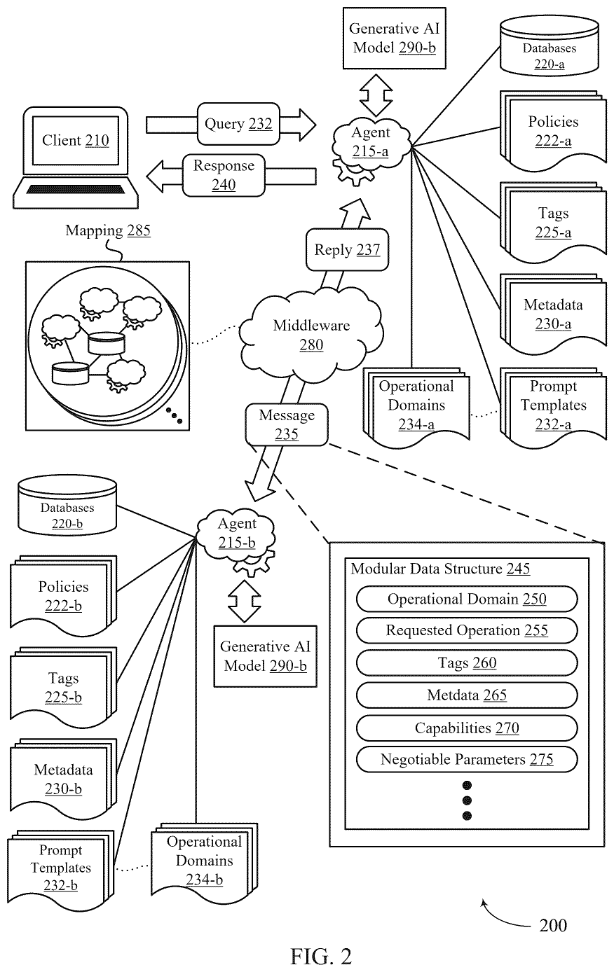

FIG. 2 shows an example of a system 200 that supports policy-based inter-agent communication control in accordance with examples as disclosed herein. The system 200 includes various elements and any or all elements of the system 200 may be implemented on one or more servers, cloud platforms, processing environments, application-specific hardware, other hardware, or any combination thereof.

In some systems, autonomous agents may be employed to perform tasks (e.g., interact with users and provide information or perform one or more operations). However, some approaches for the use of agents may be improved. For example, such approaches may suffer from a lack of communication control and policy enforcement. Current frameworks lack mechanisms to define and enforce structured policies governing how agents interact and share information. This can lead to unauthorized data access, communication redundancy, and inconsistent decision-making, undermining system reliability and trust.

Additionally, or alternatively, such approaches may suffer from unrestricted data access and segmentation issues. The use of agents may involve varying levels of access to enterprise data, but without proper segmentation, sensitive information can be inadvertently exposed. For example, sales agents might access proprietary inventory details that should remain confidential, leading to security vulnerabilities and compliance violations.

Additionally, or alternatively, such approaches may suffer from contextual role-based policy gaps. Autonomous agents often operate in role-specific contexts. While a sales agent may only utilize summary data on product availability, a logistics agent might utilize real-time, granular data. The inability to define and enforce policies based on such contextual roles hampers operational efficiency and creates risks of overexposure or underutilization of critical data.

Additionally, or alternatively, such approaches may suffer from inefficiency in autonomous decision-making. Autonomous decision-making may lack safeguards to promote alignment with organizational policies, privacy laws, and industry-specific regulations like the General Data Protection Regulation (GDPR) or the Health Insurance Portability and Accountability Act (HIPAA). This increases the risk of regulatory non-compliance and reduces the effectiveness of automation.

Additionally, or alternatively, such approaches may suffer from complexity in many-to-many agent relationships or an inability to handle such complexity. Multi-agent systems often involve complex, dynamic relationships, where multiple agents simultaneously access shared resources. Without flexible, context-aware interaction mapping, these relationships become unmanageable, leading to resource conflicts, redundant communication, and fragmented decision-making.

Such issues may lead to various consequences, such as privacy and security risks. For example, unregulated agent communication and unrestricted data access may create vulnerabilities for data breaches, privacy violations, and unauthorized information sharing, damaging organizational integrity. Additionally, or alternatively, such issues may lead to operational inefficiency. Unnecessary or uncontrolled inter-agent communication leads to delays, resource wastage, and potential conflicts between agents, reducing overall system efficiency. Additionally, or alternatively, such issues may lead to regulatory compliance challenges. Failure to enforce compliance in autonomous operations can result in violations of legal and industry standards, incurring fines, reputational damage, and operational disruptions. Additionally, or alternatively, such issues may lead to reduced trust and adoption. Organizations and users may lose confidence in systems that involve agents when communication lacks transparency and control, hindering adoption and scalability.

To reduce or resolve such issues and the consequences of such issues, the subject matter described herein provides a policy-driven, contextually adaptive communication framework for autonomous multi-agent systems. By combining policy-based structured control with dynamic negotiation and contextual interaction capabilities, the system promotes secure, efficient, and compliant communication among agents. The subject matter described herein leverages advanced tagging, modular data structures (e.g., context-aware data exchange capsules), and a universal adaptive middleware to manage communication and decision-making. This promotes the seamless operation of autonomous agents across diverse domains while mitigating risks associated with unregulated communication.

For example, the client 210 may transmit a query 232 to the agent 215-a. The agent 215-a and the agent 215-b may be agents associated with a same cloud platform or different cloud platforms. Further, the agent 215-a may be associated with one or more databases 220-a, one or more policies 222-a, one or more tags 225-a, metadata 230-a, one or more prompt templates 232-a, one or more operational domains 234-a, or any combination thereof.

In some examples, such operational domains 234 may be contexts, roles, operations, scenarios, or other organizations of information and operations in accordance with which an agent 215 may operate. For example, an operational domain 234 may be an inventory management operational domain or a customer information operational domain. An operational domain 234 may describe or be associated with information, operations, or both, that may be available to the agent 215 to perform one or more tasks, services, or roles associated with the agent 215. In some examples, a single agent 215 may be associated with multiple operational domains 234 and may operate in accordance with one or more such operational domains 234 from time to time (e.g., for interactions with users or with other agents).

In some examples, the system 200 or one or more elements thereof (e.g., the middleware 280, an agent 215, or other element) may determine one or more operational domains 234 associated with that same element or associated with another element. For example, an agent 215 interacting with a user may determine one or more operational domains 234 in accordance with which the agent 215 may operate in response to the user interaction. Additionally, or alternatively, an agent 215 may determine that another agent 215 is operating in accordance with an operational domain 234 (e.g., through an indication in the modular data structure 245 or by analyzing behavior of the another agent 215).

In some examples, such prompt templates 232-a may be templates for creating a prompt that may be provided to a generative AI model 290-b or LLM. Such templates may include one or more instructions, grounding information, or other information to which additional, situation-specific information may be added. For example, for a given interaction with an agent 215 (e.g., and one or more associated processing tasks or other operations), context-specific or interaction-specific information may be added to the prompt template to orient the generative AI model 290-b for processing requests. In some examples, the prompt templates 232-a may include information or instructions that may guide or prime the generative AI model 290-b for processing tasks for agent interactions (e.g., general information or instructions that may be applicable across various agent interactions, operational domains 234-a, or other scenarios). Further, in some examples, the prompt templates 232-a may include information that may be based on the various policies 222, tags 225, metadata 230, operational domains 234, or any other information or operations described herein.

In some examples, the agent 215-b may be associated with one or more databases 220-b, one or more policies 222-b, one or more tags 225-b, metadata 230-b, one or more prompt templates 232-b, one or more operational domains 234-b, or any combination thereof. In some examples, data in the databases 220-a and the databases 220-b, other datastores, or any combination thereof, may be tagged data. Such tags may correspond with one or more tags associated with the agents 215, which may implicitly or explicitly provide a mapping (e.g., which may be reflected in the mapping 285) between agents 215 and databases 220 or data stored therein. For example, the system 200 (e.g., one or more elements thereof) may receive information from the agents 215, databases 220, one or more other elements of the system 200, or any combination thereof, that indicates the tags 225, operational domains 234, or any other information described herein. The system 200 (e.g., the one or more elements thereof) may construct the mapping 285 by determining that elements of the system 200 include, possess, or are associated with the same or compatible tags 225. In some examples, the system 200 may determine that one or more elements of the system (e.g., multiple agents 215) have interacted with one another (e.g., a quantity of occasions that satisfies an interaction occasion threshold or an amount of time that satisfies an interaction time threshold) and may map the multiple agents together in the mapping 285. Such a determination may be based on interactions, whereas other mappings in the mapping 285 may be based on explicit indications (e.g., tags 225, operational domains 234, or any other indication or information described herein).

In some examples, a policy 222 (or multiple policies) may be based on the mapping 285. For example, a policy 222 may indicate that elements of the system 200 that include, possess, or are associated with one or more tags 225 may be permitted to access information, request operations, or perform operations. Additionally, or alternatively, the policy may indicate that such elements of the system 200 that are mapped together in the mapping 285 are permitted to interact (e.g., request information or operations, or provide information or perform operations).

In some examples, the agent 215-a may transmit a message 235 to the agent 215-b. The message 235 may include, indicate, or be based on a modular data structure 245. Such a modular data structure 245 may include some or all of the elements or parameters described herein, including one or more of the following (including the possibility of multiple instances of some or all of the following): an operational domain 250, a requested operation 255 (e.g., an operation that is requested by the agent 215-a to be performed by the agent 215-b), one or more tags 260 (e.g., associated with the agent 215-a, the databases 220-a, one or more other elements described herein, or any combination thereof), metadata 265, capabilities 270 (e.g., capabilities of the agent 215-a or the agent 215-b), one or more negotiable parameters 275 (though any of the parameters included or indicated in the message 235 may, in some examples, be negotiated between the agents 215), any other element or information described herein, or any combination thereof. For example, the agent 215-a may request that the agent 215-b perform a requested operation 255 and may further indicate an operational domain 234-a that is associated with the agent 215-a. For example, the agent 215-a may request that the agent 215-b perform a requested operation 255 that involves tagged data stored at one or more of the databases 220-b. In some examples, the modular data structure 245 may support multiple configurations of such information and a selection of such information included in given configurations may differ. Further, additional information (e.g., one or more indications of any information or operations described herein) may be included in the modular data structure 245 to support inter-agent interactions. Such an arrangement may provide additional flexibility and reduced overhead compared to other data structures (e.g., static data structures) that require a given set of information to be included or that set aside space for such information, as some information may not be applicable to a given scenario (e.g., increasing overhead without benefit) and other information that may be helpful or desirable for the agent interactions may not be included in such a data structure (e.g., reducing performance).

In some examples, the negotiable parameters 275 may include one or more parameters that may be negotiated or determined by one or more agents 215. For example, the agent 215-a may indicate in the negotiable parameters multiple items of information to be retrieved from the databases 220-b. The agent 215-b may determine that the agent 215-a may access a first item of information but not a second item of information. The agent 215-b may modify one or more of the negotiable parameters 275 to reflect the permission of access to the first item and denial of access to the second item of information.

In some examples, the agent 215-b may verify (e.g., based on one or more items of information included or indicated in the message 235 such as the operation domain 250), one or more items of information available to the agent 215-b (e.g., the one or more databases 220-b, one or more policies 222-b, one or more tags 225-b, metadata 230-b, one or more prompt templates 232-b, one or more operational domains 234-b, or any combination thereof). For example, the agent 215-b may verify, based at least in part on the operational domain 234 indicated in the modular data structure 245 and a tag associated with data of the databases 220-b, whether the requested operation 255 is permitted. For example, one or more of the policies 222-b may indicate whether an agent 215 of one or more operational domains 234-a may access the tagged data included in the databases 220-b. In some cases, the policies 222-b may indicate different operations or levels of access for different operational domains 234-a (e.g., roles). Such permissions may differ by situation, even if a same agent 215 is requesting access, as a same agent 215 may operate in accordance with different operational domains 234 in various scenarios.

The agent 215-b may (e.g., in response to verifying that the requested operation 255 is permitted or not based on a policy 222-b or multiple such policies 222-b) transmit the reply 237 to the message 235. For example, if the requested operation 255 is permitted based on a policy 222-b, the reply 237 may indicate that the requested operation 255 was permitted and a result of the operation may be included or indicated in the reply 237. For example, information retrieved from the databases 220-b may be included or indicated in the reply 237. Additionally, or alternatively, if the requested operation 255 is not permitted based on a policy 222-b, the reply 237 may indicate that the requested operation 255 was not permitted. In either case (or in other scenarios or situations), the agent 215-b may transmit the reply 237 and the reply 237 or contents or indications thereof may be in accordance with one or more policies 222-b or other policies associated with the system 200 (e.g., the policies 222-a or other policies).

In some examples, the agent 215-a may transmit a response 240 to the query 232 based on the reply 237 to the message 235. For example, the response 240 may indicate or include the information retrieved from the databases 220-b or an indication of the requested operation 255 being performed (e.g., an operation performed on or in association with the data of the databases 220-b). Additionally, or alternatively, the agent 215-a may initiate a series of interactions with one or more other agents 215, some or all of which may involve multiple messages 235, replies 237, other interactions, or any combination thereof. In some examples, the response 240 may be transmitted to the user after such multiple messages 235, replies 237, other interactions, associated processing operations, or any combination thereof, are communicated or performed. In some examples, other agents (e.g., the agent 215-b) may itself perform one or more interactions with one or more additional agents to support accomplishing the original request 235 from the agent 215-a. Such “chained,” “cascading,” or recursive interactions may continue for any quantity of repetitions or iterations as determined to be appropriate by the agents 215 or any other element of the system (e.g., the middleware 280).

In some examples, the agents 215 may perform operations (e.g., those described herein) using generative AI processing. For example, the agent 215-a may interpret incoming information using the generative AI model 290-a and may further generate outgoing information using the generative AI model 290-a. Similarly, the agent 215-b may interpret incoming information using the generative AI model 290-b and may further generate outgoing information using the generative AI model 290-b. Any operations described herein as being associated with the agents 215 may be performed, at least in part, through the use of a generative AI model 290. In some examples, the generative AI model 290-a and the generative AI model 290-b may be a same generative AI model or may be different generative AI models. Further, in some cases, an agent 215 may utilize different generative AI models 290 in association with different operational domains 234, contexts, or scenarios. For example, some generative AI models 290 may be trained for more specific tasks that may be more suitable for some scenarios and less suitable for others.

In some examples, the system 200 may implement or include dynamic policy framework for communication control between agents 215. For example, the policies 222 may be associated with one or more operational domains 234 or may be specific to one or more operational domains 234, providing context-aware policy enforcement based on task and regulatory considerations. Further, the policies 222 may be adjusted by the system 200 in real time, periodically, or on demand. For example, the system 200 may adjust, create, delete, or otherwise modify the policies 222 based on the mapping 285, administrator or user input, environmental factors, regulations, any other information described herein, or any combination thereof.

In some examples, data segmentation and tagging may be performed. For example, the data in the databases 220 may be segmented based on tags applied to the data in the databases 220, thereby further increasing security and limiting access to the data only by those agents 215 that carry tags (e.g., for one or more operational domains 234) that correspond to the tags of the data. For example, database resources, structured data (e.g., structured query language (SQL) data) and unstructured (e.g., JavaScript Object Notation (JSON) data), may be tagged for specific access levels, operations (e.g., READ, WRITE, PROHIBITED), or any combination thereof, to promote compliance and security. In some examples, the corresponding tags 225 associated with agents 215 may serve to classify the agents by operational domain 234, permissions, and operational context, some or all of which may align with the tags of the data in the databases 220.

In some examples, the modular data structure 245 may also be referred to as a context-aware communication capsule (CAC). The modular data structure 245 may be exchanged between agents 215 to facilitate enforcement of the policies 222. For example, the modular data structure 245 may include one or more indications that may reflect the intent or requested operations of an agents. The modular data structure 245 may include context information, such as environmental and task-specific metadata, which may be included in the metadata 230. The modular data structure 245 may include one or more capabilities 270, which may include or indicate one or more functional resources or constraints of an agent 215. The modular data structure 245 may include or indicate a negotiation space, which may include or indicate the negotiable parameters 275 or other parameters. In some examples, the modular data structure 245 may be designed or configured for both human readability and machine processing (e.g., via JSON for linking data (JSON-LD) or other formats).

In some examples, the system 200 may include the middleware 280. The middleware 280 may be adaptive universal middleware that acts as an intelligent intermediary for inter-agent communication. For example, the middleware 280 may translate CACs or modular data structures 245 into agent-specific formats (e.g., using semantic mapping). Additionally, or alternatively, the middleware 280 may evolve or otherwise be modified through machine learning and reinforcement learning based on prior interactions (e.g., agent-to-agent interactions or agent-to-user interactions) and outcomes.

In some examples, the system 200 may employ the use of autonomous negotiation protocols. Such protocols may permit agents 215 to negotiate task-sharing and resource allocation dynamically with one another. These protocols may utilize role-based prioritization, adaptive trade-offs, collaborative improvement techniques, reinforcement learning, or any combination thereof, to refine negotiation strategies over time, improving task efficiency and outcomes.

In some examples, each agent 215 may include a meta-persona layer to align communication styles with the preferences or capabilities of other agents. Such a meta-persona layer may dynamically adjust interaction modalities (e.g., formal, concise, verbose) to ensure interoperability across heterogeneous systems. Further, such a meta-persona layer may manage the various operations domains 234-a or roles that may be performed by the agents 215. For example, the meta-persona layer may determine one or more operational domains 234 under which an agent 215 is to operate (e.g., based on interactions with a user, administrator input, or any other information associated with the system) and may provide an indication of one or more selected operational domains 234 that are to be employed for operations (e.g., for interactions with a user or to be indicated in a modular data structure 245). In some examples, the agents 215 may (e.g., through the use of the meta-persona layer) negotiate roles or operational domains 234 with one another and share tasks while operating in accordance with constraints (e.g., the policies 222). For example, multiple agents 215 may communicate and determine a first operational domain 234-a for a first agent 215-a and a second operational domain 234-b for a second agent 215-b based on one or more factors (e.g., availability of data associated with the operational domains 234, permissions associated with the one or more agents 215, capabilities of the agents 215, or any other information described herein). In some examples, a default operational domain 234-a may be employed. For example, such a “default” operational domain 234-a may be employed in cases in which an agent 215 is not associated with any other operational domains 234, in cases in which existing operational domains 234 are determined to not be applicable, in cases in which one or more errors occur, or in one or more other scenarios.

In some examples, the system 200 may provide mechanisms for defining the policies 222. For example, an administrator may initially define one or more policies 222 and the system may further update one or more policies 222 based on operations of the system, such as agent-to-agent interactions.

In some examples, the system 200 may categorize or classify the agents 215 with the use of the tags 225, which may be used in concert with tags that categorize or classify data of the databases 220. Further, the middleware 280 or other element of the system 200 may specify or record associations of database tables or other data in response to such data being consumed in interactions (e.g., agent-to-agent interactions) between different tag clouds of data. For example, the mapping 285 may include mappings between agents 215, tagged data (e.g., data tables, “clouds” of tags associated with data, such as related data), or any combination thereof.

An example may be illustrative. In some examples, tags may be applied to data in an inventory database. If a structured database is used for storing the inventory details, then the tagging may be attached to different fields, columns, or other divisions of data and stored in a metadata. Alternatively, for unstructured databases like JSON documents, the tagging can be specified for each element in the JSON structure. Further, the policies 222 may be specified. For example, while interacting with a sales agent (e.g., which may be an example of an operational domain 234), any access to inventory tags A, B, C are prohibited. Further, READ-ONLY access is available for D, E, F tags and READ-WRITE access is available for G, H tags. Thus, once the agents are configured as above (e.g., are assigned tags 225 that may be associated with an operational domain 234), malicious or inadvertent access of data via agent-to-agent interactions can be reduced or eliminated. Additionally, or alternatively, an access policy 222 may refer to a combination of an operation (eg an aggregation operation or other operation) and a tag 225 to define one or more aspects of a policy 222. For example, a sales agent may be prohibited from accessing the unique serial number of any individual product in inventory store (e.g., tag X), but it should be permitted to access a COUNT( ) aggregate operation that may consider the X tag, to get a count of unique serial numbers in the inventory (e.g., essentially, a total quantity of products available in the store). Though the COUNT( ) operation is provided here as an example, any operation may be similarly paired with a tag 225 to define a policy 222 or other operation or element of the system 200.

Another example may be illustrative. In a retail environment, sales, inventory, and logistics agents may interact dynamically. For example, the sales agent may request stock details from the inventory agent via modular data structures 245 (e.g., CACs). The policy engine may provide access to non-sensitive fields and deny access to sensitive fields. The inventory agent may negotiate with the logistics agent to prioritize replenishments based on supply routes and stock levels. The logistics agent may align its decisions or determinations with weather forecasts provided by a climate-monitoring agent. The middleware 280 may monitor interactions and promote compliance with privacy and operational policies.

In some examples, for structured databases, tags applied to data (e.g., data of the databases 220) may be stored in metadata tables linked to columns, rows, or other divisions of data. For unstructured data, hierarchical JSON paths or XML nodes may be tagged for role-specific access.

In some examples, policies may be defined using declarative formats like YAML or JSON, specifying role-based conditions, data access permissions, and operational constraints. An example policy may be expressed as follows:

### Unset

{

“AgentRole”: “Sales”,
“ProhibitedTags”: [“Inventory.A”, “Inventory.B”],
“ReadOnlyTags”: [“Inventory.D”, “Inventory.E”],
“ReadWriteTags”: [“Inventory.F”]

}

In some examples, a middleware learning pipeline may be employed. Such a pipeline may log interactions between agents 215 to a distributed ledger for traceability, analysis, and subsequent processing. The middleware learning pipeline may use these logs to train reinforcement learning models that improve communication protocols.

In some examples, the system 200 may include security and compliance integration. Such operations or mechanisms may align with GDPR, HIPAA, and industry-specific regulations and make adjustments to policies 222 or other aspects of the system 200 to promote decision making by the agents 215 that falls within the considerations of such regulations or laws. For example, if personally-identifiable information is stored in a database 220, access to such information may be limited to those agents 215 that have a legitimate purpose (e.g., associated with an operational domain 234) to access such information.

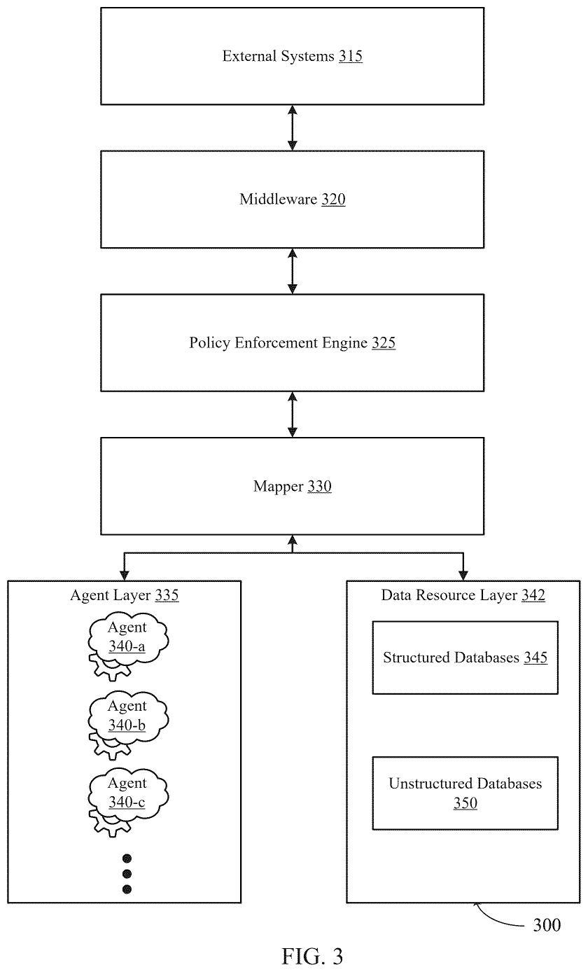

FIG. 3 shows an example of a system 300 that supports policy-based inter-agent communication control in accordance with examples as disclosed herein. The system 300 may include or relate to one or more external systems 315, middleware 320, a policy enforcement engine 325, a mapper 330, an agent layer 335 associated with one or more agents 340 (e.g., agent 340-a, agent 340-b, and agent 340-c), a data resource layer 342 (e.g., associated with a structured database 345, an unstructured database 350), or any combination thereof.

In some examples, the external systems 315 may include one or more systems for regulatory compliance, monitoring systems, or any other systems with which a system (e.g., the system 200) may interact. In some examples, the external systems 315 may include or operate in conjunction with APIs or other interfaces to communicate information to aid the operation of the system 300.

The middleware 320 may include or perform operations such as translation of modular data structures 245 (e.g., CACs) between formats used by agents 340. The middleware 320 may also perform contextual interaction management, which may include providing or managing contexts and metadata that may be used by the agents 340 to govern their agent-to-agent interactions. In some examples, the middleware 320 may perform reinforcement learning for adaptive communication, to refine agent-to-agent negotiation strategies over time, improving task efficiency and outcomes, as well as improving communication protocols (e.g., involving the modular data structures 245 or other communication methods or operations). In some examples, though the middleware 320 is depicted as being separate from the policy enforcement engine 325 and the mapper 330, such elements may be considered part of the middleware 320 (e.g., as represented in the middleware 280 of the system 200, in which some or all of the elements of the system 300 may be represented by the middleware 280).

In some examples, the policy enforcement engine 325 may include elements or perform operations involving role-based access control (RBAC) which may define access control based on operational domains (e.g., roles) that may provide access to data or operations based on an operational domain of an agent 340. The policy enforcement engine 325 may further manage other data access policies, which may be related to laws, regulations, sensitive information, or other data access considerations. In some examples, the policy enforcement engine 325 may generate, modify, remove, or manage the policies (e.g., the policies 222) to which the agents 340 may be subject in the course of operation.

In some examples, the mapper 330 may map tags of agents 340 to tags applied to data (e.g., in the structured databases 345, the unstructured databases 350, or both) and may further generate or determine contextual interaction definitions (e.g., definitions of different contexts, interactions, scenarios, operational domains, or other definitions that influence how the agents 340 may interact with one another). For example, the mapper 330 may create the mapping 285 depicted in FIG. 2.

In some examples, the agent layer 335 may include or be associated with the various agents 340 that communicate with one another in accordance with the subject matter described herein. In some examples, the data resource layer 342 may include or be associated with datastores, such as the structured databases 345, the unstructured databases 350, or both, that may house data communicated or reference by operations of the agents 340 in agent-to-agent interactions.

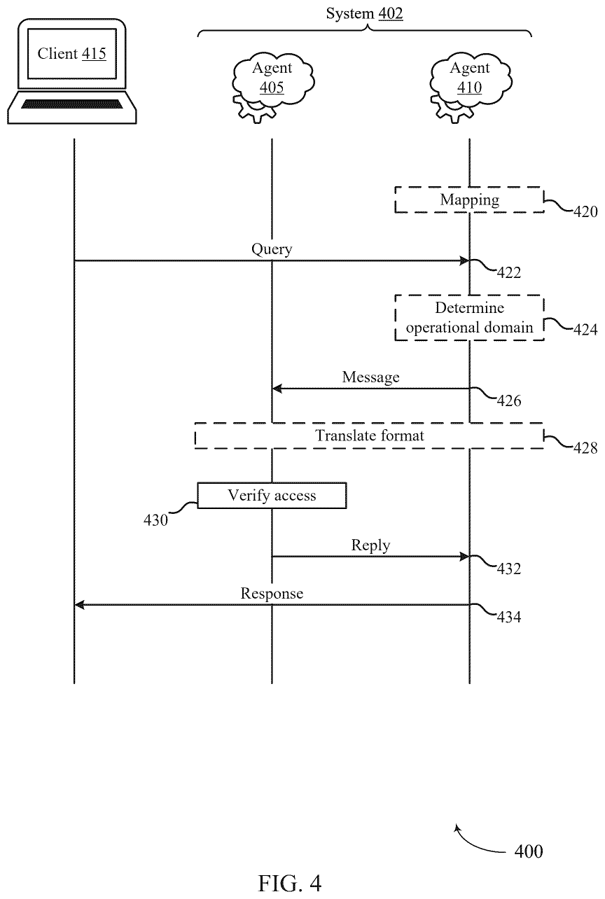

FIG. 4 shows an example of a process flow 400 that supports policy-based inter-agent communication control in accordance with examples as disclosed herein. The process flow 400 may implement various aspects of the present disclosure described herein. The elements described in the process flow 400 (e.g., system 402, first agent 405, and second agent 410) may be examples of similarly named elements described herein.

In the following description of the process flow 400, the operations between the various entities or elements may be performed in different orders or at different times. Some operations may also be left out of the process flow 400, or other operations may be added. Although the various entities or elements are shown performing the operations of the process flow 400, some aspects of some operations may also be performed by other entities or elements of the process flow 400 or by entities or elements that are not depicted in the process flow, or any combination thereof.

In some examples, at 420, the system 402 may map a plurality of agent tags associated with the plurality of agents with a plurality of data tags of the tagged data. Additionally, or alternatively, the system 402 may generate a mapping between individual agent tags associated with individual agents of the plurality of agents based on agent-to-agent interactions between the individual agents of a plurality of agents. For example, the system 402 (e.g., one or more elements thereof, such as the agent 410) may receive information from agents, databases, one or more other elements of the system 402, or any combination thereof, that indicates one or more tags, operational domains, or any other information described herein. The system 402 (e.g., the one or more elements thereof) may construct the mapping by determining that elements of the system 402 (or other elements) include, possess, or are associated with the same or compatible tags. In some examples, an agent access policy may be based on the mapping. For example, the agent access policy may indicate that elements of the system 402 that include, possess, or are associated with one or more tags may be permitted to access information or request operations. Additionally, or alternatively, the agent access policy may indicate that elements that are mapped together in the mapping are permitted to interact (e.g., request information or operations, or provide information or perform operations).

In some examples, at 422, the system 402 may receive (e.g., from the client 415) a query via an interface associated with a first agent 405 of the plurality of agents configured for user communications and inter-agent communications and each respective agent of the plurality of agents is associated with a respective plurality of LLM prompt templates according to which the respective agent performs LLM operations, the plurality of LLM prompt templates associated with a plurality of operational domains for the respective agent, and wherein the plurality of agents is configured to access one or more data stores that may include tagged data.

In some examples, at 424, the system 402 may determine the operational domain of the first agent 405 based on one or more queries received by the first agent 405, one or more operations performed by the first agent 405, one or more messages communicated by the first agent 405, or any combination thereof. For example, the agent 410 may determine one or more operational domains in accordance with which the agent 410 is to operate to respond to the query 422 (e.g., through an identification of one or more elements included in the query that are associated with or map to one or more operational domains 424).

In some examples, at 426, the system 402 may transmit, from the first agent 405 to a second agent 410 of the plurality of agents, a message indicating an operational domain and a requested operation involving first data of the tagged data. In some examples, the message may include a modular data structure that may include an indication of the operational domain, an indication of the requested operation, an indication of metadata associated with the operational domain, an indication of metadata associated with the requested operation, an indication of one or more capabilities of the first agent 405, one or more parameters associated with the query that are negotiable by the first agent 405 and the second agent 410, or any combination thereof.

In some examples, at 428, the system 402 may translate, with middleware associated with the first agent 405 and the second agent 410, the modular data structure from a first format associated with the first agent 405 to a second format associated with the second agent 410.

In some examples, at 430, the system 402 may verify, based on the operational domain and a tag associated with the first data, whether the requested operation is permitted by an agent access policy that indicates a plurality of tags and one or more respective permitted operations associated with each respective tag of the plurality of tags. In some examples, the agent access policy is based on the mapping. In some examples, to verify whether the requested operation is permitted, the system 402 may compare a first tag associated with the first agent 405 to a first tag of the plurality of tags. In some examples, the agent access policy may indicate one or more conditions that, if satisfied, permit performance of the requested operation. In some examples, the agent access policy may indicate a default operational domain associated with one or more default permitted operations.

In some examples, at 432, the system 402 may transmit, from the second agent 410 to the first agent 405 and based on the verification, a reply to the message that is in accordance with the agent access policy.

In some examples, at 434, the system 402 may transmit, from the first agent 405 and via the interface, a response to the query based on the reply to the message.

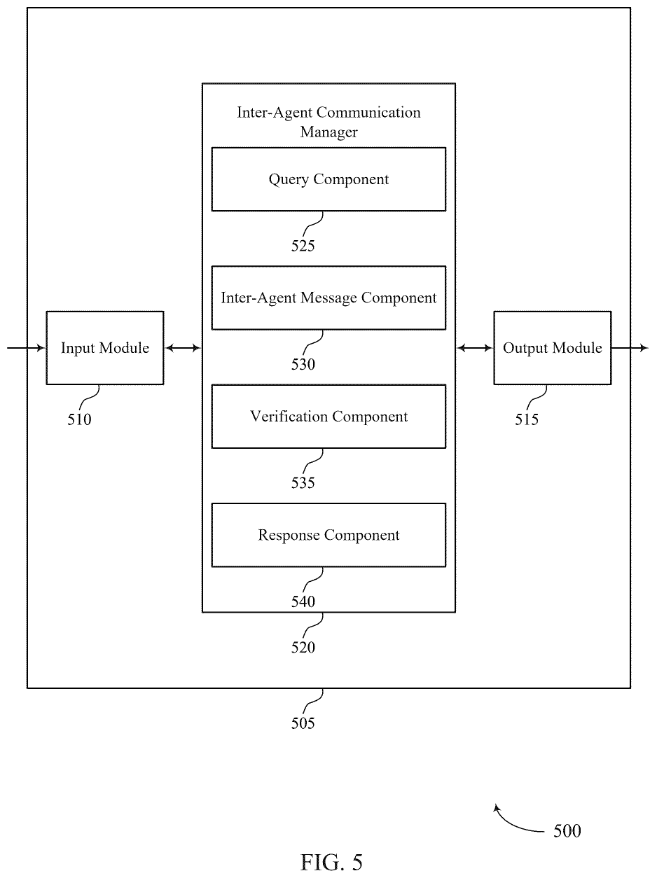

FIG. 5 shows a block diagram 500 of a device 505 that supports policy-based inter-agent communication control in accordance with examples as disclosed herein. The device 505 may include an input module 510, an output module 515, and an inter-agent communication manager 520. The device 505, or one or more components of the device 505 (e.g., the input module 510, the output module 515, the inter-agent communication manager 520), may include at least one processor, which may be coupled with at least one memory, to support the described techniques. Each of these components may be in communication with one another (e.g., via one or more buses).

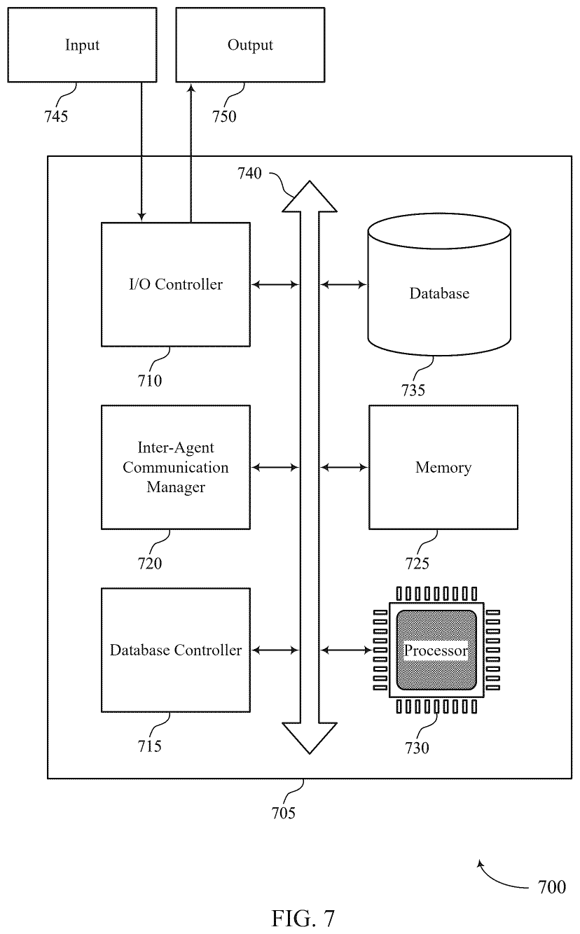

The input module 510 may manage input signals for the device 505. For example, the input module 510 may identify input signals based on an interaction with a modem, a keyboard, a mouse, a touchscreen, or a similar device. These input signals may be associated with user input or processing at other components or devices. In some cases, the input module 510 may utilize an operating system such as iOS®, ANDROID®, MS-DOS®, MS-WINDOWS®, OS/2®, UNIX®, LINUX®, or another known operating system to handle input signals. The input module 510 may send aspects of these input signals to other components of the device 505 for processing. For example, the input module 510 may transmit input signals to the inter-agent communication manager 520 to support policy-based inter-agent communication control. In some cases, the input module 510 may be a component of an input/output (I/O) controller 710 as described with reference to FIG. 7.

The output module 515 may manage output signals for the device 505. For example, the output module 515 may receive signals from other components of the device 505, such as the inter-agent communication manager 520, and may transmit these signals to other components or devices. In some examples, the output module 515 may transmit output signals for display in a user interface, for storage in a database or data store, for further processing at a server or server cluster, or for any other processes at any number of devices or systems. In some cases, the output module 515 may be a component of an I/O controller 710 as described with reference to FIG. 7.

For example, the inter-agent communication manager 520 may include a query component 525, an inter-agent message component 530, a verification component 535, a response component 540, or any combination thereof. In some examples, the inter-agent communication manager 520, or various components thereof, may be configured to perform various operations (e.g., receiving, monitoring, transmitting) using or otherwise in cooperation with the input module 510, the output module 515, or both. For example, the inter-agent communication manager 520 may receive information from the input module 510, send information to the output module 515, or be integrated in combination with the input module 510, the output module 515, or both to receive information, transmit information, or perform various other operations as described herein.

The inter-agent communication manager 520 may support data processing in accordance with examples as disclosed herein. The query component 525 may be configured to support receiving a query via an interface associated with a first agent of a set of multiple agents configured for user communications and inter-agent communications, where each respective agent of the set of multiple agents is associated with a respective set of multiple LLM prompt templates according to which the respective agent performs LLM operations, the set of multiple LLM prompt templates associated with a set of multiple operational domains for the respective agent, and where the set of multiple agents is configured to access one or more data stores including tagged data. The inter-agent message component 530 may be configured to support transmitting, from the first agent to a second agent of the set of multiple agents, a message indicating an operational domain and a requested operation involving first data of the tagged data. The verification component 535 may be configured to support verifying, based on the operational domain and a tag associated with the first data, whether the requested operation is permitted by an agent access policy that indicates a set of multiple tags and one or more respective permitted operations associated with each respective tag of the set of multiple tags. The inter-agent message component 530 may be configured to support transmitting, from the second agent to the first agent and based on the verification, a reply to the message that is in accordance with the agent access policy. The response component 540 may be configured to support transmitting, from the first agent and via the interface, a response to the query based on the reply to the message.

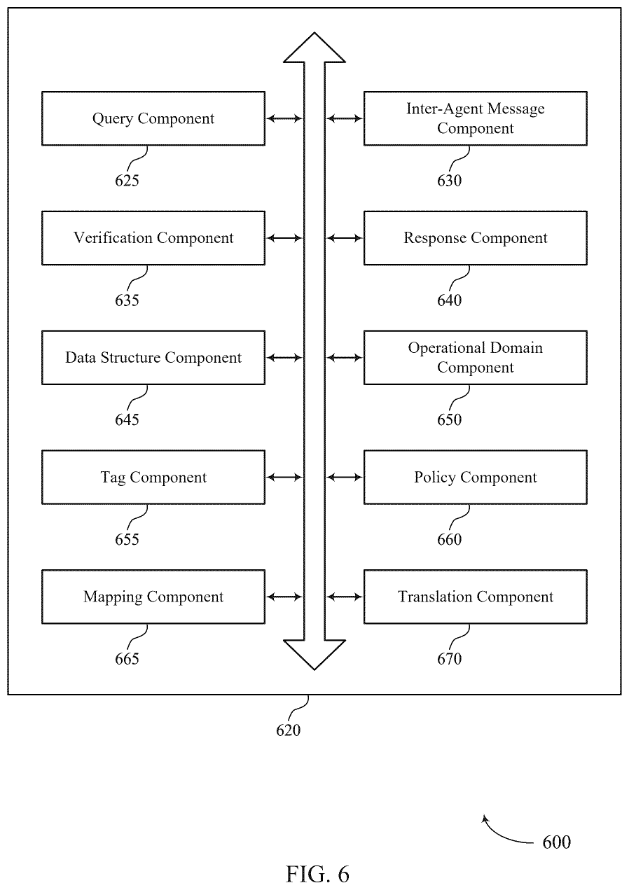

FIG. 6 shows a block diagram 600 of an inter-agent communication manager 620 that supports policy-based inter-agent communication control in accordance with examples as disclosed herein. The inter-agent communication manager 620 may be an example of aspects of an inter-agent communication manager or an inter-agent communication manager 520, or both, as described herein. The inter-agent communication manager 620, or various components thereof, may be an example of means for performing various aspects of policy-based inter-agent communication control as described herein. For example, the inter-agent communication manager 620 may include a query component 625, an inter-agent message component 630, a verification component 635, a response component 640, a data structure component 645, an operational domain component 650, a tag component 655, a policy component 660, a mapping component 665, a translation component 670, or any combination thereof. Each of these components, or components of subcomponents thereof (e.g., one or more processors, one or more memories), may communicate, directly or indirectly, with one another (e.g., via one or more buses).

The inter-agent communication manager 620 may support data processing in accordance with examples as disclosed herein. The query component 625 may be configured to support receiving a query via an interface associated with a first agent of a set of multiple agents configured for user communications and inter-agent communications, where each respective agent of the set of multiple agents is associated with a respective set of multiple LLM prompt templates according to which the respective agent performs LLM operations, the set of multiple LLM prompt templates associated with a set of multiple operational domains for the respective agent, and where the set of multiple agents is configured to access one or more data stores including tagged data. The inter-agent message component 630 may be configured to support transmitting, from the first agent to a second agent of the set of multiple agents, a message indicating an operational domain and a requested operation involving first data of the tagged data. The verification component 635 may be configured to support verifying, based on the operational domain and a tag associated with the first data, whether the requested operation is permitted by an agent access policy that indicates a set of multiple tags and one or more respective permitted operations associated with each respective tag of the set of multiple tags. In some examples, the inter-agent message component 630 may be configured to support transmitting, from the second agent to the first agent and based on the verification, a reply to the message that is in accordance with the agent access policy. The response component 640 may be configured to support transmitting, from the first agent and via the interface, a response to the query based on the reply to the message.

In some examples, the message includes a modular data structure including an indication of the operational domain, an indication of the requested operation, an indication of metadata associated with the operational domain, an indication of metadata associated with the requested operation, an indication of one or more capabilities of the first agent, one or more parameters associated with the query that are negotiable by the first agent and the second agent, or any combination thereof.

In some examples, the translation component 670 may be configured to support translating, with middleware associated with the first agent and the second agent, the modular data structure from a first format associated with the first agent to a second format associated with the second agent.

In some examples, the operational domain component 650 may be configured to support determining the operational domain of the first agent based on one or more queries received by the first agent, one or more operations performed by the first agent, one or more messages communicated by the first agent, or any combination thereof.

In some examples, the tag component 655 may be configured to support mapping a set of multiple agent tags associated with the set of multiple agents with a set of multiple data tags of the tagged data. In some examples, the policy component 660 may be configured to support where the agent access policy is based on the mapping.

In some examples, the mapping component 665 may be configured to support generating a mapping between individual agent tags associated with individual agents of the set of multiple agents based on agent-to-agent interactions between the individual agents of the set of multiple agents. In some examples, the policy component 660 may be configured to support where the agent access policy is based on the mapping.

In some examples, to support verifying whether the requested operation is permitted, the tag component 655 may be configured to support comparing a first tag associated with the first agent to a first tag of the set of multiple tags.

In some examples, the agent access policy indicates one or more conditions that, if satisfied, permit performance of the requested operation.

In some examples, the agent access policy indicates a default operational domain associated with one or more default permitted operations.

FIG. 7 shows a diagram of a system 700 including a device 705 that supports policy-based inter-agent communication control in accordance with examples as disclosed herein. The device 705 may be an example of or include components of a device 505 as described herein. The device 705 may include components for bi-directional data communications including components for transmitting and receiving communications, such as an inter-agent communication manager 720, an I/O controller, such as an I/O controller 710, a database controller 715, at least one memory 725, at least one processor 730, and a database 735. These components may be in electronic communication or otherwise coupled (e.g., operatively, communicatively, functionally, electronically, electrically) via one or more buses (e.g., a bus 740).

The I/O controller 710 may manage input signals 745 and output signals 750 for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. In other cases, the I/O controller 710 may represent or interact with a modem, a keyboard, a mouse, a touchscreen, or a similar device. In some cases, the I/O controller 710 may be implemented as part of a processor 730. In some examples, a user may interact with the device 705 via the I/O controller 710 or via hardware components controlled by the I/O controller 710.

The database controller 715 may manage data storage and processing in a database 735. In some cases, a user may interact with the database controller 715. In other cases, the database controller 715 may operate automatically without user interaction. The database 735 may be an example of a single database, a distributed database, multiple distributed databases, a data store, a data lake, or an emergency backup database.

Memory 725 may include random-access memory (RAM) and read-only memory (ROM). The memory 725 may store computer-readable, computer-executable software including instructions that, when executed, cause at least one processor 730 to perform various functions described herein. In some cases, the memory 725 may contain, among other things, a basic I/O system (BIOS) which may control basic hardware or software operation such as the interaction with peripheral components or devices. The memory 725 may be an example of a single memory or multiple memories. For example, the device 705 may include one or more memories 725.

The processor 730 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 730 may be configured to operate a memory array using a memory controller. In other cases, a memory controller may be integrated into the processor 730. The processor 730 may be configured to execute computer-readable instructions stored in at least one memory 725 to perform various functions (e.g., functions or tasks supporting policy-based inter-agent communication control). The processor 730 may be an example of a single processor or multiple processors. For example, the device 705 may include one or more processors 730.

The inter-agent communication manager 720 may support data processing in accordance with examples as disclosed herein. For example, the inter-agent communication manager 720 may be configured to support receiving a query via an interface associated with a first agent of a set of multiple agents configured for user communications and inter-agent communications, where each respective agent of the set of multiple agents is associated with a respective set of multiple LLM prompt templates according to which the respective agent performs LLM operations, the set of multiple LLM prompt templates associated with a set of multiple operational domains for the respective agent, and where the set of multiple agents is configured to access one or more data stores including tagged data. The inter-agent communication manager 720 may be configured to support transmitting, from the first agent to a second agent of the set of multiple agents, a message indicating an operational domain and a requested operation involving first data of the tagged data. The inter-agent communication manager 720 may be configured to support verifying, based at least in part on the operational domain and a tag associated with the first data, whether the requested operation is permitted by an agent access policy that indicates a set of multiple tags and one or more respective permitted operations associated with each respective tag of the set of multiple tags. The inter-agent communication manager 720 may be configured to support transmitting, from the second agent to the first agent and based on the verification, a reply to the message that is in accordance with the agent access policy. The inter-agent communication manager 720 may be configured to support transmitting, from the first agent and via the interface, a response to the query based on the reply to the message.

By including or configuring the inter-agent communication manager 720 in accordance with examples as described herein, the device 705 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

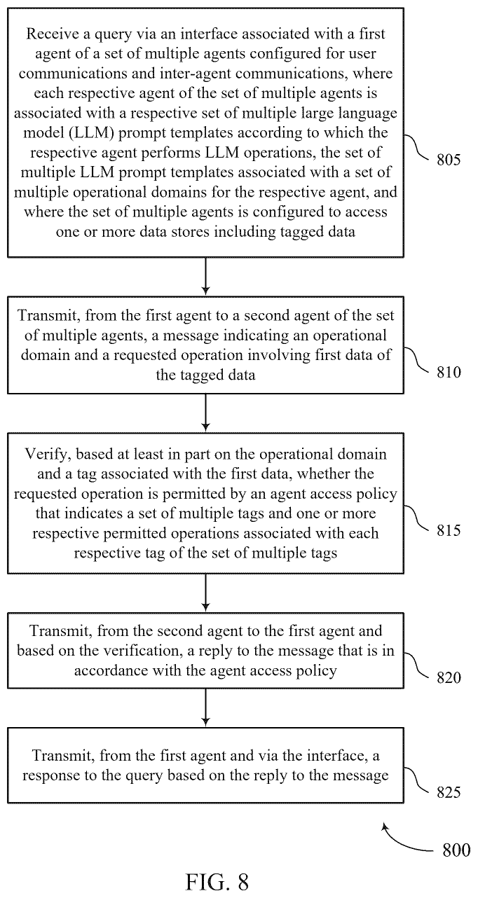

FIG. 8 shows a flowchart illustrating a method 800 that supports policy-based inter-agent communication control in accordance with examples as disclosed herein. The operations of the method 800 may be implemented by an application server or its components as described herein. For example, the operations of the method 800 may be performed by an application server as described with reference to FIGS. 1 through 7. In some examples, an application server may execute a set of instructions to control the functional elements of the application server to perform the described functions. Additionally, or alternatively, the application server may perform aspects of the described functions using special-purpose hardware.

At 805, the method may include receiving a query via an interface associated with a first agent of a set of multiple agents configured for user communications and inter-agent communications, where each respective agent of the set of multiple agents is associated with a respective set of multiple LLM prompt templates according to which the respective agent performs LLM operations, the set of multiple LLM prompt templates associated with a set of multiple operational domains for the respective agent, and where the set of multiple agents is configured to access one or more data stores including tagged data. The operations of 805 may be performed in accordance with examples as disclosed herein. In some examples, aspects of the operations of 805 may be performed by a query component 625 as described with reference to FIG. 6.

At 810, the method may include transmitting, from the first agent to a second agent of the set of multiple agents, a message indicating an operational domain and a requested operation involving first data of the tagged data. The operations of 810 may be performed in accordance with examples as disclosed herein. In some examples, aspects of the operations of 810 may be performed by an inter-agent message component 630 as described with reference to FIG. 6.

At 815, the method may include verifying, based on the operational domain and a tag associated with the first data, whether the requested operation is permitted by an agent access policy that indicates a set of multiple tags and one or more respective permitted operations associated with each respective tag of the set of multiple tags. The operations of 815 may be performed in accordance with examples as disclosed herein. In some examples, aspects of the operations of 815 may be performed by a verification component 635 as described with reference to FIG. 6.

At 820, the method may include transmitting, from the second agent to the first agent and based on the verification, a reply to the message that is in accordance with the agent access policy. The operations of 820 may be performed in accordance with examples as disclosed herein. In some examples, aspects of the operations of 820 may be performed by an inter-agent message component 630 as described with reference to FIG. 6.

At 825, the method may include transmitting, from the first agent and via the interface, a response to the query based on the reply to the message. The operations of 825 may be performed in accordance with examples as disclosed herein. In some examples, aspects of the operations of 825 may be performed by a response component 640 as described with reference to FIG. 6.

A method for data processing by an apparatus is described. The method may include receiving a query via an interface associated with a first agent of a set of multiple agents configured for user communications and inter-agent communications, where each respective agent of the set of multiple agents is associated with a respective set of multiple LLM prompt templates according to which the respective agent performs LLM operations, the set of multiple LLM prompt templates associated with a set of multiple operational domains for the respective agent, and where the set of multiple agents is configured to access one or more data stores including tagged data, transmitting, from the first agent to a second agent of the set of multiple agents, a message indicating an operational domain and a requested operation involving first data of the tagged data, verifying, based on the operational domain and a tag associated with the first data, whether the requested operation is permitted by an agent access policy that indicates a set of multiple tags and one or more respective permitted operations associated with each respective tag of the set of multiple tags, transmitting, from the second agent to the first agent and based on the verification, a reply to the message that is in accordance with the agent access policy, and transmitting, from the first agent and via the interface, a response to the query based on the reply to the message.

An apparatus for data processing is described. The apparatus may include one or more memories storing processor executable code, and one or more processors coupled with the one or more memories. The one or more processors may individually or collectively be operable to execute the code to cause the apparatus to receive a query via an interface associated with a first agent of a set of multiple agents configured for user communications and inter-agent communications, where each respective agent of the set of multiple agents is associated with a respective set of multiple LLM prompt templates according to which the respective agent performs LLM operations, the set of multiple LLM prompt templates associated with a set of multiple operational domains for the respective agent, and where the set of multiple agents is configured to access one or more data stores including tagged data, transmit, from the first agent to a second agent of the set of multiple agents, a message indicating an operational domain and a requested operation involving first data of the tagged data, verifying, based at least in part on the operational domain and a tag associated with the first data, whether the requested operation is permitted by an agent access policy that indicates a set of multiple tags and one or more respective permitted operations associated with each respective tag of the set of multiple tags, transmit, from the second agent to the first agent and based on the verification, a reply to the message that is in accordance with the agent access policy, and transmit, from the first agent and via the interface, a response to the query based on the reply to the message.

Another apparatus for data processing is described. The apparatus may include means for receiving a query via an interface associated with a first agent of a set of multiple agents configured for user communications and inter-agent communications, where each respective agent of the set of multiple agents is associated with a respective set of multiple LLM prompt templates according to which the respective agent performs LLM operations, the set of multiple LLM prompt templates associated with a set of multiple operational domains for the respective agent, and where the set of multiple agents is configured to access one or more data stores including tagged data, means for transmitting, from the first agent to a second agent of the set of multiple agents, a message indicating an operational domain and a requested operation involving first data of the tagged data, means for verifying, based on the operational domain and a tag associated with the first data, whether the requested operation is permitted by an agent access policy that indicates a set of multiple tags and one or more respective permitted operations associated with each respective tag of the set of multiple tags, means for transmitting, from the second agent to the first agent and based on the verification, a reply to the message that is in accordance with the agent access policy, and means for transmitting, from the first agent and via the interface, a response to the query based on the reply to the message.

A non-transitory computer-readable medium storing code for data processing is described. The code may include instructions executable by one or more processors to receive a query via an interface associated with a first agent of a set of multiple agents configured for user communications and inter-agent communications, where each respective agent of the set of multiple agents is associated with a respective set of multiple LLM prompt templates according to which the respective agent performs LLM operations, the set of multiple LLM prompt templates associated with a set of multiple operational domains for the respective agent, and where the set of multiple agents is configured to access one or more data stores including tagged data, transmit, from the first agent to a second agent of the set of multiple agents, a message indicating an operational domain and a requested operation involving first data of the tagged data, verifying, based at least in part on the operational domain and a tag associated with the first data, whether the requested operation is permitted by an agent access policy that indicates a set of multiple tags and one or more respective permitted operations associated with each respective tag of the set of multiple tags, transmit, from the second agent to the first agent and based on the verification, a reply to the message that is in accordance with the agent access policy, and transmit, from the first agent and via the interface, a response to the query based on the reply to the message.

In some examples of the method, apparatus, and non-transitory computer-readable medium described herein, the message includes a modular data structure including an indication of the operational domain, an indication of the requested operation, an indication of metadata associated with the operational domain, an indication of metadata associated with the requested operation, an indication of one or more capabilities of the first agent, one or more parameters associated with the query that may be negotiable by the first agent and the second agent, or any combination thereof.

Some examples of the method, apparatus, and non-transitory computer-readable medium described herein may further include operations, features, means, or instructions for translating, with middleware associated with the first agent and the second agent, the modular data structure from a first format associated with the first agent to a second format associated with the second agent.

Some examples of the method, apparatus, and non-transitory computer-readable medium described herein may further include operations, features, means, or instructions for determining the operational domain of the first agent based on one or more queries received by the first agent, one or more operations performed by the first agent, one or more messages communicated by the first agent, or any combination thereof.

Some examples of the method, apparatus, and non-transitory computer-readable medium described herein may further include operations, features, means, or instructions for mapping a set of multiple agent tags associated with the set of multiple agents with a set of multiple data tags of the tagged data and where the agent access policy may be based on the mapping.

Some examples of the method, apparatus, and non-transitory computer-readable medium described herein may further include operations, features, means, or instructions for generating a mapping between individual agent tags associated with individual agents of the set of multiple agents based on agent-to-agent interactions between the individual agents of the set of multiple agents and where the agent access policy may be based on the mapping.

In some examples of the method, apparatus, and non-transitory computer-readable medium described herein, verifying whether the requested operation may be permitted may include operations, features, means, or instructions for comparing a first tag associated with the first agent to a first tag of the set of multiple tags.

In some examples of the method, apparatus, and non-transitory computer-readable medium described herein, the agent access policy indicates one or more conditions that, if satisfied, permit performance of the requested operation.

In some examples of the method, apparatus, and non-transitory computer-readable medium described herein, the agent access policy indicates a default operational domain associated with one or more default permitted operations.

The following provides an overview of aspects of the present disclosure:
Aspect 1: A method for data processing, comprising: receiving a query via an interface associated with a first agent of a plurality of agents configured for user communications and inter-agent communications, wherein each respective agent of the plurality of agents is associated with a respective plurality of LLM prompt templates according to which the respective agent performs LLM operations, the plurality of LLM prompt templates associated with a plurality of operational domains for the respective agent, and wherein the plurality of agents is configured to access one or more data stores comprising tagged data; transmitting, from the first agent to a second agent of the plurality of agents, a message indicating an operational domain and a requested operation involving first data of the tagged data; verifying, based at least in part on the operational domain and a tag associated with the first data, whether the requested operation is permitted by an agent access policy that indicates a plurality of tags and one or more respective permitted operations associated with each respective tag of the plurality of tags; transmitting, from the second agent to the first agent and based at least in part on the verification, a reply to the message that is in accordance with the agent access policy; and transmitting, from the first agent and via the interface, a response to the query based at least in part on the reply to the message.
Aspect 2: The method of aspect 1, wherein the message comprises a modular data structure comprising an indication of the operational domain, an indication of the requested operation, an indication of metadata associated with the operational domain, an indication of metadata associated with the requested operation, an indication of one or more capabilities of the first agent, one or more parameters associated with the query that are negotiable by the first agent and the second agent, or any combination thereof.
Aspect 3: The method of aspect 2, further comprising: translating, with middleware associated with the first agent and the second agent, the modular data structure from a first format associated with the first agent to a second format associated with the second agent.
Aspect 4: The method of any of aspects 1 through 3, further comprising: determining the operational domain of the first agent based at least in part on one or more queries received by the first agent, one or more operations performed by the first agent, one or more messages communicated by the first agent, or any combination thereof.
Aspect 5: The method of any of aspects 1 through 4, further comprising: mapping a plurality of agent tags associated with the plurality of agents with a plurality of data tags of the tagged data; wherein the agent access policy is based at least in part on the mapping.
Aspect 6: The method of any of aspects 1 through 5, further comprising: generating a mapping between individual agent tags associated with individual agents of the plurality of agents based at least in part on agent-to-agent interactions between the individual agents of the plurality of agents; wherein the agent access policy is based at least in part on the mapping.
Aspect 7: The method of any of aspects 1 through 6, wherein verifying whether the requested operation is permitted comprises: comparing a first tag associated with the first agent to a first tag of the plurality of tags.
Aspect 8: The method of any of aspects 1 through 7, wherein the agent access policy indicates one or more conditions that, if satisfied, permit performance of the requested operation.
Aspect 9: The method of any of aspects 1 through 8, wherein the agent access policy indicates a default operational domain associated with one or more default permitted operations.
Aspect 10: An apparatus for data processing, comprising one or more memories storing processor-executable code, and one or more processors coupled with the one or more memories and individually or collectively operable to execute the code to cause the apparatus to perform a method of any of aspects 1 through 9.
Aspect 11: An apparatus for data processing, comprising at least one means for performing a method of any of aspects 1 through 9.
Aspect 12: A non-transitory computer-readable medium storing code for data processing, the code comprising instructions executable by one or more processors to perform a method of any of aspects 1 through 9.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data processing, comprising:
receiving a query via an interface associated with a first agent of a plurality of agents configured for user communications and inter-agent communications, wherein each respective agent of the plurality of agents is associated with a respective plurality of large language model (LLM) prompt templates according to which the respective agent performs LLM operations, the plurality of LLM prompt templates associated with a plurality of operational domains for the respective agent, and wherein the plurality of agents is configured to access one or more data stores comprising tagged data;
transmitting, from the first agent to a second agent of the plurality of agents, a message indicating an operational domain and a requested operation involving first data of the tagged data;
verifying, based at least in part on the operational domain and a tag associated with the first data, whether the requested operation is permitted by an agent access policy that indicates a plurality of tags and one or more respective permitted operations associated with each respective tag of the plurality of tags;
transmitting, from the second agent to the first agent and based at least in part on the verifying, a reply to the message that is in accordance with the agent access policy; and
transmitting, from the first agent and via the interface, a response to the query based at least in part on the reply to the message.

2. The method of claim 1, wherein the message comprises a modular data structure comprising an indication of the operational domain, an indication of the requested operation, an indication of metadata associated with the operational domain, an indication of metadata associated with the requested operation, an indication of one or more capabilities of the first agent, one or more parameters associated with the query that are negotiable by the first agent and the second agent, or any combination thereof.

3. The method of claim 2, further comprising:
translating, with middleware associated with the first agent and the second agent, the modular data structure from a first format associated with the first agent to a second format associated with the second agent.

4. The method of claim 1, further comprising:
determining the operational domain of the first agent based at least in part on one or more queries received by the first agent, one or more operations performed by the first agent, one or more messages communicated by the first agent, or any combination thereof.

5. The method of claim 1, further comprising:
mapping a plurality of agent tags associated with the plurality of agents with a plurality of data tags of the tagged data;
wherein the agent access policy is based at least in part on the mapping.

6. The method of claim 1, further comprising:
generating a mapping between individual agent tags associated with individual agents of the plurality of agents based at least in part on agent-to-agent interactions between the individual agents of the plurality of agents;
wherein the agent access policy is based at least in part on the mapping.

7. The method of claim 1, wherein verifying whether the requested operation is permitted comprises:
comparing a first tag associated with the first agent to a first tag of the plurality of tags.

8. The method of claim 1, wherein the agent access policy indicates one or more conditions that, if satisfied, permit performance of the requested operation.

9. The method of claim 1, wherein the agent access policy indicates a default operational domain associated with one or more default permitted operations.

10. An apparatus for data processing, comprising:
one or more memories storing processor-executable code; and
one or more processors coupled with the one or more memories and individually or collectively operable to execute the code to cause the apparatus to:
receive a query via an interface associated with a first agent of a plurality of agents configured for user communications and inter-agent communications, wherein each respective agent of the plurality of agents is associated with a respective plurality of large language model (LLM) prompt templates according to which the respective agent performs LLM operations, the plurality of LLM prompt templates associated with a plurality of operational domains for the respective agent, and wherein the plurality of agents is configured to access one or more data stores comprising tagged data;
transmit, from the first agent to a second agent of the plurality of agents, a message indicating an operational domain and a requested operation involving first data of the tagged data;
verifying, based at least in part on the operational domain and a tag associated with the first data, whether the requested operation is permitted by an agent access policy that indicates a plurality of tags and one or more respective permitted operations associated with each respective tag of the plurality of tags;
transmit, from the second agent to the first agent and based at least in part on the verifying, a reply to the message that is in accordance with the agent access policy; and
transmit, from the first agent and via the interface, a response to the query based at least in part on the reply to the message.

11. The apparatus of claim 10, wherein the message comprises a modular data structure comprising an indication of the operational domain, an indication of the requested operation, an indication of metadata associated with the operational domain, an indication of metadata associated with the requested operation, an indication of one or more capabilities of the first agent, one or more parameters associated with the query that are negotiable by the first agent and the second agent, or any combination thereof.

12. The apparatus of claim 11, wherein the one or more processors are individually or collectively further operable to execute the code to cause the apparatus to:
translate, with middleware associated with the first agent and the second agent, the modular data structure from a first format associated with the first agent to a second format associated with the second agent.

13. The apparatus of claim 10, wherein the one or more processors are individually or collectively further operable to execute the code to cause the apparatus to:
determine the operational domain of the first agent based at least in part on one or more queries received by the first agent, one or more operations performed by the first agent, one or more messages communicated by the first agent, or any combination thereof.

14. The apparatus of claim 10, wherein the one or more processors are individually or collectively further operable to execute the code to cause the apparatus to:
map a plurality of agent tags associated with the plurality of agents with a plurality of data tags of the tagged data;
wherein the agent access policy is based at least in part on the mapping.

15. The apparatus of claim 10, wherein the one or more processors are individually or collectively further operable to execute the code to cause the apparatus to:
generate a mapping between individual agent tags associated with individual agents of the plurality of agents based at least in part on agent-to-agent interactions between the individual agents of the plurality of agents;
wherein the agent access policy is based at least in part on the mapping.

16. The apparatus of claim 10, wherein, to verify whether the requested operation is permitted, the one or more processors are individually or collectively operable to execute the code to cause the apparatus to:
compare a first tag associated with the first agent to a first tag of the plurality of tags.

17. The apparatus of claim 10, wherein the agent access policy indicates one or more conditions that, if satisfied, permit performance of the requested operation.

18. The apparatus of claim 10, wherein the agent access policy indicates a default operational domain associated with one or more default permitted operations.

19. A non-transitory computer-readable medium storing code for data processing, the code comprising instructions executable by one or more processors to:
receive a query via an interface associated with a first agent of a plurality of agents configured for user communications and inter-agent communications, wherein each respective agent of the plurality of agents is associated with a respective plurality of large language model (LLM) prompt templates according to which the respective agent performs LLM operations, the plurality of LLM prompt templates associated with a plurality of operational domains for the respective agent, and wherein the plurality of agents is configured to access one or more data stores comprising tagged data;
transmit, from the first agent to a second agent of the plurality of agents, a message indicating an operational domain and a requested operation involving first data of the tagged data;
verifying, based at least in part on the operational domain and a tag associated with the first data, whether the requested operation is permitted by an agent access policy that indicates a plurality of tags and one or more respective permitted operations associated with each respective tag of the plurality of tags;
transmit, from the second agent to the first agent and based at least in part on the verifying, a reply to the message that is in accordance with the agent access policy; and
transmit, from the first agent and via the interface, a response to the query based at least in part on the reply to the message.

20. The non-transitory computer-readable medium of claim 19, wherein the message comprises a modular data structure comprising an indication of the operational domain, an indication of the requested operation, an indication of metadata associated with the operational domain, an indication of metadata associated with the requested operation, an indication of one or more capabilities of the first agent, one or more parameters associated with the query that are negotiable by the first agent and the second agent, or any combination thereof.
